(19) United States
(12) Patent Application Publication
(10) Pub. No.: US 2026/0179943 A1
(43) Pub. Date: Jun. 25, 2026

(54) LOW CRYSTALLINITY VANADIUM SULFIDE

(71) Applicants: NATIONAL INSTITUTE OF ADVANCED INDUSTRIAL SCIENCE AND TECHNOLOGY, Tokyo (JP); HONDA MOTOR CO., LTD., Tokyo (JP)

(72) Inventors: Tomonari TAKEUCHI, Tsukuba-shi (JP); Toshikatsu KOJIMA, Tsukuba-shi, Ibaraki (JP); Toyoki OKUMURA, Tsukuba-shi, Ibaraki (JP); Hayato TAKAHASHI, Wako-shi, Saitama (JP)

(21) Appl. No.: 19/430,888

(22) Filed: Dec. 23, 2025

(30) Foreign Application Priority Data
Dec. 25, 2024 (JP) 2024-229251

(51) Int. Cl. H01M 4/58; C01G 31/00; H01M 4/136; H01M 10/0525

(52) U.S. Cl. CPC H01M 4/5815; C01G 31/00; H01M 4/136; H01M 10/0525; C01P 2002/04; C01P 2004/61

(57) ABSTRACT

Provided is an electrode active material for lithium-ion secondary batteries exhibiting excellent capacity. Specifically, provided is a low-crystalline vanadium sulfide comprising vanadium and sulfur as constituent elements, wherein the composition ratio of the sulfur to the vanadium (S/V) is 3.5 or more in terms of the molar ratio, the average particle size D50 is 10 μm or less, and the low-crystalline vanadium sulfide has no peak at 2θ=53.0° with a tolerance of ±1.0° in an X-ray diffractogram obtained using Cu Kα radiation.

### TECHNICAL FIELD

The present invention relates to a low-crystalline vanadium sulfide.

### BACKGROUND ART

Since portable electronic devices, hybrid vehicles, etc. have had higher performance in recent years, the lithium-ion secondary batteries used for such devices are increasingly required to have higher capacity. However, for current lithium-ion secondary batteries, the development of higher-capacity cathodes lags behind the development of higher-capacity anodes. Even lithium nickel oxide-based materials, which are said to have a relatively high capacity, have a capacity of only about 190 to 220 mAh/g.

In contrast, sulfur, which has a theoretical capacity of as high as about 1670 mAh/g, is a promising candidate for a cathode material. However, sulfur has low electronic conductivity, as well as the problem of dissolution as lithium polysulfide into an organic electrolyte during charging and discharging. Therefore, a technique for suppressing dissolution into an organic electrolyte is essential.

Metal sulfides are electronically conductive and also have reduced dissolution into an organic electrolyte. However, metal sulfides have lower theoretical capacities than sulfur and also have the problem of low reversibility due to a great structural change resulting from Li insertion and extraction during charging and discharging. To increase the capacities of metal sulfides, increasing sulfur content is necessary. However, since the sites of crystalline metal sulfides into which Li can be inserted during discharging are defined by crystal space groups, and this determines the maximum capacity, it is difficult to exceed this maximum capacity value.

For example, as a vanadium sulfide among metal sulfides, when crystalline vanadium(III) sulfide (V_{2.0}S_{3.0}) sold as a reagent is used as a cathode active material, its actual measured discharge capacity is only about 52 mAh/g, and its charge capacity is only about 23 mAh/g although the theoretical capacity is as high as 811.0 mAh/g because a reaction with an organic electrolyte cannot be suppressed. Non-patent Literature 1 proposes using VS₄-rGO, which is a nanocomposite with graphene oxide prepared by a hydrothermal synthesis method, as an anode material for lithium-ion secondary batteries because it has high rate capability. However, this material is crystalline. Even when such a nanocomposite with another material is formed, the sites into which Li can be inserted during discharging are defined by crystal space groups, and this determines the maximum capacity. Thus, there is room for improvement in capacity.

In view of the above, the present inventors conducted extensive research and found that a specific low-crystalline vanadium sulfide allows an improvement in the actual capacity (see Patent Literature 1).

### CITATION LIST

### Patent Literature

PTL 1: WO2018/181698

### Non-Patent Literature

NPL 1: X. Xu et al., J. Mater. Chem. A, 2. (2014) 10847-10853

### SUMMARY OF INVENTION

### Technical Problem

However, impurities (for example, oxides, such as V₂O₃) cannot be sufficiently removed from the low-crystalline vanadium sulfide. Therefore, although vanadium sulfides have a high theoretical capacity and are thus expected to have the potential to produce lithium-ion secondary batteries with high capacity, there remains room for improvement in actual measured capacity.

Accordingly, an object of the present invention is to provide an electrode active material for lithium-ion secondary batteries that exhibits excellent capacity.

### Solution to Problem

The present inventors conducted extensive research to achieve the above object and found that a uniform and fine low-crystalline vanadium sulfide can be obtained by applying specific reaction conditions, and that the thus-obtained low-crystalline vanadium sulfide exhibits high capacity when used as an electrode active material for lithium-ion secondary batteries. The present invention has been accomplished through further research based on this finding. Specifically, the present invention includes the following.

Item 1. A low-crystalline vanadium sulfide comprising vanadium and sulfur as constituent elements,
wherein the composition ratio of the sulfur to the vanadium (S/V) is 3.5 or more in terms of the molar ratio,
the average particle size D50 is 10 μm or less, and
the low-crystalline vanadium sulfide has no peak at a diffraction angle of 2θ=53.0° with a tolerance of ±1.0° in an X-ray diffractogram obtained using Cu Kα radiation.

Item 2. The low-crystalline vanadium sulfide according to Item 1, which has a composition represented by formula (1):

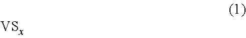

wherein x is 3.5 or more.

Item 3. The low-crystalline vanadium sulfide according to Item 1 or 2, which has a VS₄-type crystal structure.

Item 4. The low-crystalline vanadium sulfide according to any one of Items 1 to 3,
wherein the low-crystalline vanadium sulfide has peaks at 2θ=15.8° and 17.0° with a tolerance of ±1.0° in the X-ray diffractogram, and crystallite sizes calculated from the full widths at half maximum of the peaks at 2θ=15.8° and 17.0° are both 15 nm or less.

Item 5. The low-crystalline vanadium sulfide according to any one of Items 1 to 4,
wherein the low-crystalline vanadium sulfide has no peaks at 2θ=24.4° and 33.0° with a tolerance of ±1.0° in the X-ray diffractogram, or
the areas of peaks with local maxima at 2θ=24.4° and 33.0° are both 20% or less of the area of the smaller of the two peaks with local maxima at 2θ=15.8° and 17.0° with a tolerance of ±1.0° in the X-ray diffractogram.

Item 6. A method for producing the low-crystalline vanadium sulfide according to any one of Items 1 to 5, comprising:
a hydrothermal treatment step of subjecting a raw material containing a vanadate and a sulfur-containing compound to hydrothermal treatment at 100° C. to 160° C. in the absence of a carrier.

Item 7. The production method according to Item 6, wherein the amount of the sulfur-containing compound used is 3.5 to 5.0 mol per mol of the vanadate.

Item 8. An electrode active material for lithium-ion secondary batteries, comprising the low-crystalline vanadium sulfide according to any one of Items 1 to 5.

Item 9. An electrode for lithium-ion secondary batteries, comprising the electrode active material for lithium-ion secondary batteries according to Item 8.

Item 10. A lithium-ion secondary battery comprising the electrode for lithium-ion secondary batteries according to Item 9.

### Advantageous Effects of Invention

The low-crystalline vanadium sulfide of the present invention is a material capable of significantly improving specific capacity as compared to conventional vanadium sulfides.

### BRIEF DESCRIPTION OF DRAWINGS

FIG. 1 shows X-ray diffractograms of the powders obtained in Example 1, Comparative Example 1, and Comparative Example 2. The peaks of crystalline vanadium (IV) tetrasulfide (VS₄) and crystalline divanadium trioxide (V₂O₃) are also shown.

FIG. 2 shows HR-TEM images of the powder obtained in Example 1.

FIG. 3 shows HR-TEM images of the powder obtained in Comparative Example 1.

FIG. 4 shows HR-TEM images of the powder obtained in Comparative Example 2.

FIG. 5 shows the particle size distribution (histogram) of the powder obtained in Example 1.

FIG. 6 shows discharge specific capacities at 25° C. and 60° C. of the powders obtained in Example 1 and Comparative Example 2.

### DESCRIPTION OF EMBODIMENTS

In the present specification, “contain” and “comprise” include the concepts of comprising, consisting essentially of, and consisting of.

In the present specification, the expression “A to B” means “A or more and B or less.”

Further, in the present specification, the concept of “lithium-ion secondary battery” also includes lithium secondary batteries containing lithium metal as an anode active material.

### 1. Low-Crystalline Vanadium Sulfide

The low-crystalline vanadium sulfide of the present invention comprises vanadium and sulfur as constituent elements,
wherein the composition ratio of the sulfur to the vanadium (S/V) is 3.5 or more in terms of the molar ratio,
the average particle size D50 is 10 μm or less, and
the low-crystalline vanadium sulfide has no peak at a diffraction angle of 2θ=53.0° with a tolerance of ±1.0° in an X-ray diffractogram obtained using Cu Kα radiation.

More specifically, the low-crystalline vanadium sulfide of the present invention preferably has a composition represented by formula (1):

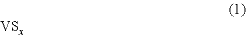

wherein x is 3.5 or more.

Accordingly, the low-crystalline vanadium sulfide of the present invention has a high element ratio of sulfur to vanadium. Thus, the low-crystalline vanadium sulfide of the present invention exhibits a high specific capacity. In the present invention, the higher the sulfur content (the larger x is), the more likely it is that the specific capacity will be higher, and the lower the sulfur content (the smaller x is), the less likely it is that the low-crystalline vanadium sulfide will contain elemental sulfur and the more likely it is that the cycle characteristics will be higher. In order to balance these, x is preferably 3.5 to 10.0, more preferably 3.8 to 5.0, and even more preferably 3.9 to 4.5.

The low-crystalline vanadium sulfide of the present invention preferably has an average particle size D50 of 8 μm or less, and more preferably 6 μm or less. The average particle size D50 of the low-crystalline vanadium sulfide of the present invention is preferably smaller. Although the lower limit is not particularly set, the lower limit can be, for example, 50 nm or more. In terms of the average particle size D50, it is suitable when the primary particles have an average particle size within the above ranges, and the secondary particles may also have an average particle size within these ranges.

In the present invention, the average particle size D50 is determined by a laser diffraction/scattering method and is measured, for example, under the following measurement conditions:
Device: AEROTRAC II (MicrotracBEL)
Conditions: Discharge pressure: 0.3 MPa.

The low-crystalline vanadium sulfide of the present invention preferably has a crystal structure similar to that of crystalline vanadium (IV) tetrasulfide (VS₄) (which may be referred to below as “VS₄-type crystal structure”). Of course, it is particularly preferable to use VS₄ as the vanadium sulfide. The crystalline vanadium (IV) sulfide (VS₄) is listed as 16797 in the Inorganic Crystal Structure Database (ICSD).

The low-crystalline vanadium sulfide of the present invention preferably has peaks at 2θ=15.8° and 17.0° in the diffraction angle range of 2θ=10° to 80° with a tolerance of ±1.0° in an X-ray diffractogram obtained using Cu Kα radiation. Having peaks at 2θ=15.8° and 17.0° with a tolerance of ±1.0° means having two peaks with local maxima in the ranges of 2θ=14.8° to 16.8° and 2θ=16.0° to 18.0°, respectively. When the positions of the two peaks are ambiguous due to their overlap, peak deconvolution is performed using a Gaussian function to determine the position of each peak.

The low-crystalline vanadium sulfide of the present invention preferably also has a peak at 2θ=30.1° or 2θ=36.5°, or at both (in particular, both), in the diffraction angle ranges of 2θ=10° to 80° with a tolerance of ±1.0° in an X-ray diffractogram obtained using Cu Kα radiation. Having a peak at 2θ=30.1° or 2θ=36.5°, or at both, with a tolerance of ±1.0° means having a peak with a local maximum in the range of 2θ=29.1° to 31.1°, or in the range of 2θ=35.5° to 37.5°, or in both (in particular, both).

The low-crystalline vanadium sulfide of the present invention has no peak at 2θ=53.0° in the diffraction angle range of 2θ=10° to 80° with a tolerance of ±1.0° in an X-ray diffractogram obtained using Cu Kα radiation. Having no peak at 2θ=53.0° with a tolerance of ±1.0° in an X-ray diffractogram obtained using Cu Kα radiation means having no peak in the range of 2θ=52.0° to 54.0°. Such a peak is characteristic of crystalline divanadium trioxide (V₂O₃). Thus, the low-crystalline vanadium sulfide of the present invention has a reduced content of impurities that could not previously be removed sufficiently (for example, oxides, such as V₂O₃). Accordingly, the low-crystalline vanadium sulfide of the present invention exhibits a high specific capacity.

It is also preferable that the low-crystalline vanadium sulfide of the present invention has no peaks at 2θ=24.4° and 33.0°, which are typical peak positions observed in crystalline divanadium trioxide (V₂O₃), with a tolerance of ±1.0°, or that the areas of the peaks with local maxima at these positions are both 20% or less of the area of the smaller of the two peaks with local maxima at 2θ=15.8° and 17.0°. That is, it is preferable that the low-crystalline vanadium sulfide of the present invention has no peak with a local maximum in the range of 2θ=23.4° to 25.4°, or in the range of 2θ=32.0° to 34.0°, or in both (in particular, both), or that the areas of the peaks with local maxima in the range of 2θ=23.4° to 25.4° and in the range of 2θ=32.0° to 34.0° are both 20% or less of the area of the smaller of the two peaks with local maxima in the range of 2θ=14.8° to 16.8° and in the range of 2θ=16.0° to 18.0°. Accordingly, it is preferable that the low-crystalline vanadium sulfide of the present invention does not have a crystal structure similar to that of crystalline divanadium trioxide (V₂O₃).

The low-crystalline vanadium sulfide of the present invention has a crystallite size of 15 nm or less, and more preferably 10 nm or less. The crystallite size of the low-crystalline vanadium sulfide of the present invention is preferably smaller. Although the lower limit is not particularly set, it can be, for example, 1 nm or more (for example, 5 nm or more).

In the present invention, the crystallite size is determined based on the peaks at 2θ=15.8° ((11-1) plane) and 17.0° ((020) plane) with a tolerance of ±1.0° in the X-ray diffractogram, and is calculated from the full widths at half maximum of these peaks using the Scherrer equation. More specifically, the crystallite size is calculated according to the following equation:

$$D = K λ / B cos θ$$

wherein D is the crystallite size, λ is the wavelength of the X-ray, B is the full width at half maximum (FWHM) of the peak at 2θ=15.8° or 17.0°, θ is the diffraction angle, and K is the Scherrer constant. In the present invention, K is set to 1.0. For the full width at half maximum B, when the full widths at half maximum of the two peaks at 2θ=15.8° and 17.0° are ambiguous due to their overlap, peak deconvolution is performed using a Gaussian function to determine the full widths at half maximum of each peak.

In the present invention, the X-ray diffractogram is obtained by a powder X-ray diffraction method. For example, measurement is performed under the following measurement conditions:
Device: RINT TTR-III (Rigaku)
X-ray source: Cu Kα, 50 kV/300 mA
Measurement conditions: 2θ=10° to 80°, 0.1° step, scan rate: 0.02°/sec.

The low-crystalline vanadium sulfide of the present invention preferably exhibits no lattice fringes originating from crystalline domains in a high-resolution transmission electron microscopy (HR-TEM) image.

In the present invention, high-resolution transmission electron microscopy (HR-TEM) observation can be performed, for example, under the following measurement conditions:
Device: Talos F200X (Thermo Fisher Scientific)
Conditions: 300 kV and 300 pA.

Although the low-crystalline vanadium sulfide of the present invention has a high sulfur ratio in the average composition, little sulfur is present in the form of elemental sulfur, as described below, and sulfur is bound to vanadium to form a low-crystalline sulfide. Accordingly, due to reduced crystallinity, the low-crystalline vanadium sulfide of the present invention has a large number of sites where lithium ions can be inserted and extracted, and can have, in its structure, gaps that can serve three-dimensionally as conduction pathways for lithium. Additionally, the low-crystalline vanadium sulfide of the present invention has many advantages, including the ability to undergo three-dimensional volumetric changes during charging and discharging. Accordingly, the specific capacity can be further improved. In the present specification, the “average composition of sulfide” refers to the element ratios of all constituent elements in the whole of the sulfide.

The “low crystalline” as used in the present invention is explained below. In the low-crystalline vanadium sulfide of the present invention, the full widths at half maximum of the peaks at 2θ=15.8° and 17.0° are preferably both 0.3° to 2.5° (in particular 0.4° to 2.3°). That is, the full widths at half maximum of the peaks at 2θ=15.8° and 17.0° in the low-crystalline vanadium sulfide of the present invention are preferably greater than those of crystalline vanadium (IV) tetrasulfide (VS₄). Due to low crystallinity, the low-crystalline vanadium sulfide of the present invention has an increased number of sites where Li can be stably present, thereby improving specific capacity and cycle characteristics. When the full widths at half maximum of the two peaks at 2θ=15.8° and 17.0° are ambiguous due to their overlap, peak deconvolution is performed using a Gaussian function to determine the full widths at half maximum of each peak.

When a material containing a large amount of elemental sulfur or the like is used as an electrode active material (a cathode active material or the like), there is a concern that the electrode will become highly resistive due to the high resistivity of elemental sulfur, which reduces the utilization percentage of the electrode active material during charge-discharge reactions, resulting in insufficient capacity. In contrast, the low-crystalline vanadium sulfide of the present invention contains almost no elemental sulfur or the like; therefore, when used as an electrode active material, the low-crystalline vanadium sulfide of the present invention can achieve higher energy density without suffering from the issue in terms of a reduction in the utilization percentage.

More specifically, the most intense peak of sulfur (S₈) is present at 2θ=23.0° with a tolerance of ±1.0°. It is thus preferable that the low-crystalline vanadium sulfide of the present invention does not have a peak with a local maximum at 2θ=23.0°, which is a peak characteristic of elemental sulfur, with a tolerance of ±1.0° in an X-ray diffractogram obtained using Cu Kα radiation, or that the area of the peak with a local maximum at 2θ=23.0° is 20% or less (0 to 20%, in particular, 0.1 to 19%) of the area of the smaller of the peaks with local maxima at 2θ=15.8° and 17.0°. This allows the low-crystalline vanadium sulfide of the present invention to be a material that contains almost no elemental sulfur, further reduces concerns about a reduction in the utilization percentage of the electrode active material as described above, and enables further improvement in specific capacity.

It is also preferable that the low-crystalline vanadium sulfide of the present invention has no peaks at positions of 2θ=25.8° and 27.8°, which are peaks characteristic of elemental sulfur, with a tolerance of ±1.0° or that the areas of the peaks with local maxima at these positions are 10% or less (0 to 10%, in particular, 0.1 to 8%) of the area of the smaller of the peaks with local maxima at 2θ=15.8° and 17.0°. This allows the low-crystalline vanadium sulfide of the present invention to be a material that contains almost no elemental sulfur, further reduces concerns about a reduction in the utilization percentage of the electrode active material as described above, and enables further improvement in specific capacity.

As long as the performance of the low-crystalline vanadium sulfide of the present invention is not impaired, the low-crystalline vanadium sulfide of the present invention may also contain other impurities; however, it is preferable that impurities other than the components described above are substantially not contained. Examples of such impurities include vanadium sulfide used as a raw material, vanadium oxides (e.g., V₂O₃) that are conventionally known in the art to be typically produced as byproducts, vanadium etc. that may be mixed in raw materials, and oxygen etc. that may be mixed in raw materials or during the production process. The amount of these impurities is preferably in the range that does not impair the performance of the low-crystalline vanadium sulfide of the present invention. In general, the amount is preferably 2 mass % or less (0 mass % to 2 mass %), and more preferably 1.5 mass % or less (0 mass % to 1.5 mass %). However, as stated above, as an impurity, the elemental sulfur content is preferably as low as possible. Accordingly, the low-crystalline vanadium sulfide of the present invention has a reduced content of impurities that could not previously be removed sufficiently (for example, oxides, such as V₂O₃). The low-crystalline vanadium sulfide of the present invention thus has a high specific capacity. Further, since the low-crystalline vanadium sulfide of the present invention already has a sufficiently reduced content of impurities, steps for removing impurities (e.g., heat treatment in a reducing atmosphere) or equipment for such removal is unnecessary, which is advantageous.

The low-crystalline vanadium sulfide of the present invention, which satisfies the conditions described above, may have an intense peak at a position of g(r)=2.4 Å with a tolerance of ±0.1 Å in an X-ray/neutron pair distribution function analysis (PDF analysis). To achieve superior specific capacity and cycle characteristics, the sulfide preferably has a shoulder peak at g(r)=2.0 Å, and also has a peak at a position of g(r)=3.3 Å. In other words, it is preferable that the low-crystalline vanadium sulfide of the present invention has not only V-S bonds but also S—S bonds (disulfide bonds).

As described above, the low-crystalline vanadium sulfide of the present invention exhibits particularly superior specific capacity and is thus useful as an electrode active material for lithium-ion secondary batteries (in particular, a cathode active material for lithium-ion secondary batteries).

### 2. Production Method for Low-Crystalline Vanadium Sulfide

The low-crystalline vanadium sulfide of the present invention can be obtained by a production method comprising:
a hydrothermal treatment step of subjecting a raw material containing a vanadate and a sulfur-containing compound to hydrothermal treatment at 100° C. to 160° C. in the absence of a carrier.

As specific raw materials, examples of vanadates include ammonium vanadate (NH₄VO₃), potassium vanadate (KVO₃), and sodium vanadate (NaVO₃). Among these, ammonium vanadate (NH₄VO₃) is preferred. The vanadate is not particularly limited, and any commercially available vanadate may be used. In particular, a product with high purity is preferably used.

For the sulfur-containing compound, a compound that contains sulfur in an amount necessary to form a sulfide with the intended composition, and that yields the sulfide upon reaction with a substrate and subsequent hydrolysis can be widely used. Examples of the sulfur-containing compound include thioacetamide (C₂H₅NS) and ammonium sulfide ((NH₄)₂S). Among these, thioacetamide (C₂H₅NS) is preferred. The sulfur-containing compound used as a raw material is also not particularly limited, and any commercially available sulfur-containing compound may be used. In particular, a product with high purity is preferably used.

Since the ratio of the raw materials fed almost directly becomes the same as the ratio of the elements of the product, the mixing ratio of the raw materials may be adjusted to the same ratio as the element ratio of vanadium and sulfur in the desired low-crystalline vanadium sulfide. The amount of the sulfur-containing compound used is not particularly limited. From the viewpoint of specific capacity and cycle characteristics, the amount of the sulfur-containing compound is preferably 3.5 mol or more, more preferably 3.5 to 10.0 mol, even more preferably 3.8 to 5.0 mol, and particularly preferably 3.9 to 4.5 mol, per mol of the vanadate.

The temperature during the hydrothermal treatment step is preferably 100° C. to 140° C. from the viewpoint of specific capacity and cycle characteristics.

The pressure during the hydrothermal treatment step is preferably 0.8 atm or higher, and more preferably 1 to 2 atm from the viewpoint of specific capacity and cycle characteristics.

The duration of the hydrothermal treatment step is not particularly limited, and heating treatment can be performed for any period until the desired low-crystalline vanadium sulfide is precipitated. For example, the hydrothermal treatment can be performed for 0.1 hours to 100 hours (in particular, 1 hour to 24 hours).

Accordingly, the hydrothermal treatment step is preferably performed by allowing the hydrothermal reaction to proceed in a raw material solution containing the raw materials mentioned above. In the present specification, the term “hydrothermal reaction” refers to a chemical reaction that occurs in a chemical synthesis process (hydrothermal treatment) performed in the presence of hot water or water vapor at a temperature of 100° C. or higher and a pressure of 0.8 atm or higher (in particular, 1 atm or higher).

By performing the hydrothermal treatment step in the absence of a carrier, a low-crystalline vanadium sulfide having a small particle size and low crystallinity can be obtained. Examples of carriers include carbon carriers, such as carbon black, graphite powder, carbon nanotubes, and graphene nanoplates; and ceramic carriers, such as alumina, silica, zirconia, and titania.

### 3. Use of Low-Crystalline Vanadium Sulfide

The low-crystalline vanadium sulfide of the present invention described above exhibits, in particular, excellent specific capacity, as described above, and is thus particularly useful as an electrode active material for lithium-ion secondary batteries. Lithium-ion secondary batteries in which the low-crystalline vanadium sulfide of the present invention can be effectively used as an electrode active material (in particular, a cathode active material) may be non-aqueous electrolyte lithium-ion secondary batteries comprising a non-aqueous electrolyte as an electrolyte, or all-solid-state lithium-ion secondary batteries comprising a lithium-ion-conductive solid electrolyte.

The non-aqueous electrolyte lithium-ion secondary batteries and all-solid-state lithium-ion secondary batteries may have the same structures as known lithium-ion secondary batteries, except that the low-crystalline vanadium sulfide of the present invention is used as an electrode active material (in particular, a cathode active material).

For example, the non-aqueous electrolyte lithium-ion secondary batteries may have the same basic structures as known non-aqueous electrolyte lithium-ion secondary batteries, except that the low-crystalline vanadium sulfide of the present invention is used as an electrode active material (in particular, a cathode active material).

When the low-crystalline vanadium sulfide of the present invention is used as a cathode active material, the cathode may have the same structure as a known cathode, except that the low-crystalline vanadium sulfide of the present invention is used as a cathode active material. For example, a cathode composite containing the low-crystalline vanadium sulfide of the present invention and, if necessary, containing a conductive agent and a binder may be supported on a cathode current collector, such as Al, Ni, stainless steel, or carbon cloth. Examples of conductive agents include carbon materials, such as graphite, coke, carbon black (e.g., Ketjenblack), and acicular carbon. Examples of binders include polyvinylidene fluoride (PVDF), polytetrafluoroethylene (PTFE), polyimide (PI), polyamide, polyamideimide, polyacryl, styrene-butadiene rubber (SBR), styrene-ethylene-butylene-styrene copolymers (SEBS), carboxymethyl cellulose (CMC), and the like. These materials may be used singly or in a combination of two or more. When the low-crystalline vanadium sulfide of the present invention is not used as a cathode active material, known cathode active materials, such as lithium cobalt oxide (LiCoO₂), lithium nickel oxide (LiNiO₂), lithium manganese oxide (LiMn₂O₄), lithium iron phosphate (LiFePO₄), vanadium oxide-based materials, and sulfur-based materials, can be used as cathode active materials.

When the low-crystalline vanadium sulfide of the present invention is used as an anode active material, the anode may have the same structure as a known anode, except that the low-crystalline vanadium sulfide of the present invention is used as an anode active material. For example, an anode composite containing the low-crystalline vanadium sulfide of the present invention and, if necessary, containing a conductive agent and a binder may be supported on an anode current collector, such as Al, Ni, stainless steel, or carbon cloth. Examples of conductive agents include carbon materials, such as graphite, coke, carbon black, and acicular carbon. Examples of binders include polyvinylidene fluoride (PVDF), polytetrafluoroethylene (PTFE), polyimide (PI), polyamide, polyamideimide, polyacryl, styrene-butadiene rubber (SBR), styrene-ethylene-butylene-styrene copolymers (SEBS), carboxymethyl cellulose (CMC), and the like. These materials may be used singly or in a combination of two or more. When the low-crystalline vanadium sulfide of the present invention is not used as an anode active material, known anode active materials such as metallic lithium, carbon-based materials (e.g., activated carbon and graphite), silicon, silicon oxide, Si—SiO-based materials, and lithium titanium oxide can be used as anode active materials.

Examples of solvents for non-aqueous electrolytes include solvents known as solvents for non-aqueous lithium-ion secondary batteries, such as carbonates, ethers, nitriles, and sulfur-containing compounds. In particular, when elemental sulfur is used as a cathode active material, neither carbonates nor ethers can be used as a solvent. This is because a carbonate, if used as a solvent, reacts with elemental sulfur; whereas an ether, if used as a solvent, causes dissolution of a large amount of a sulfur component in an electrolyte, thus incurring performance degradation. In contrast, the low-crystalline vanadium sulfide of the present invention, when used as an electrode active material (in particular, a cathode active material), can solve these problems and make any of the solvents applicable, thus enhancing the selectivity of solvent used in the electrolyte.

As a separator, for example, a material that is made of a polyolefin resin, such as polyethylene or polypropylene, fluororesin, nylon, aromatic aramid, inorganic glass, or like materials and that is in the form of a porous membrane, a nonwoven fabric, a woven fabric, or the like can be used.

The all-solid-state lithium-ion secondary batteries may also have the same structures as known all-solid-state lithium-ion secondary batteries, except that the low-crystalline vanadium sulfide of the present invention is used as an electrode active material (in particular, a cathode active material). In this case, the cathode, anode, and separator may be those mentioned above.

In this case, examples of usable electrolytes include polymer solid electrolytes, such as polyethylene oxide polymer compounds, and polymer compounds comprising at least one member selected from the group consisting of polyorganosiloxane chains and polyoxyalkylene chains; sulfide solid electrolytes; oxide solid electrolytes; and the like.

The non-aqueous electrolyte lithium-ion secondary batteries and all-solid-state lithium-ion secondary batteries may also be of any shape, such as cylindrical or square.

### EXAMPLES

The present invention is described below in more detail with reference to Examples, but is not limited to the Examples below.

### Example 1: Hydrothermal Treatment

Ammonium vanadate (NH₄VO₃) and thioacetamide (C₂H₅NS) were mixed so that the mixing ratio (NH₄VO₃:C₂H₅NS) was 1:3.5 to 5.0 in terms of the molar ratio. The obtained mixture was subjected to hydrothermal treatment at 100° C. to 160° C. for 16 hours in the absence of a carrier, and then washed with water and isopropanol, thereby obtaining a vanadium sulfide powder.

### Comparative Example 1: Firing Treatment

Crystalline vanadium (III) sulfide (V₂S₃) and sulfur powder(S) were mixed so that the mixing ratio (V₂S₃:S) was 1:6 in terms of the molar ratio. The obtained mixture was vacuum-sealed in a tube and fired at 400° C. for 5 hours. Subsequently, desulfurization was performed at 200° C. for 8 hours, thereby obtaining crystalline vanadium sulfide VS₄ powder (c-VS₄).

### Comparative Example 2: Milling Treatment

In a glove box in an argon atmosphere (without exposure to the atmosphere), a 45 mL zirconia vessel containing 2.0 g of the crystalline vanadium sulfide powder (c-VS₄) obtained in Comparative Example 1 and about 500 zirconia balls with a diameter of 4 mm (90 g) was used for mechanical milling at 270 rpm for 40 hours with a ball mill apparatus (P-7 classic line, Fritsch), thereby obtaining amorphous vanadium sulfide VS₄ powder (a-VS₄). The mechanical milling treatment was performed in a container for controlling the atmosphere such that a 1-hour milling treatment was performed 40 times in total, with 15-minute pauses between the treatments.

### Test Example 1: X-Ray Diffraction

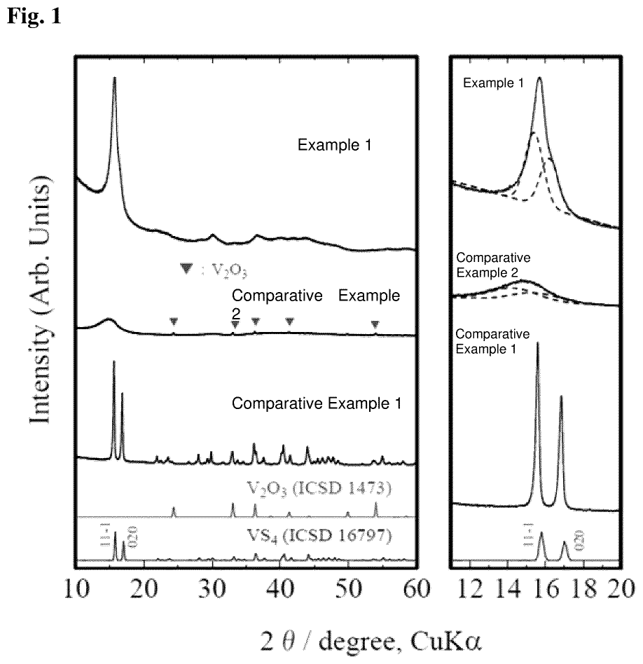

The X-ray diffraction (XRD) patterns of the powders obtained in Example 1, Comparative Example 1, and Comparative Example 2 were measured under the following conditions:
Measuring device: RINT TTR-III (Rigaku)
X-ray source: Cu Kα, 50 kV/300 mA
Measurement conditions: 2θ=10° to 80°, 0.1° step, scan rate: 0.02°/sec.
FIG. 1 shows the results. For reference, FIG. 1 also shows the peaks of crystalline vanadium (IV) sulfide (VS₄) and crystalline divanadium trioxide (V₂O₃) powder, which is an impurity.

Peak deconvolution was performed on the X-ray diffractogram shown in FIG. 1, which revealed that the powder of Example 1 had peaks at 2θ=15.8° and 17.0° in the diffraction angle range of 2θ=10° to 80°, and had a pattern similar to that of VS₄. The full widths at half maximum of these peaks were 1.12° and 1.12°, respectively, and the crystallite sizes calculated based on these values were D₍₁₁₋₁₎=8.0 nm and D₍₀₂₀₎=8.0 nm, respectively. On the other hand, no peak was observed in the vicinity of 2θ=53.0° in the X-ray diffractogram shown in FIG. 1.

Further, the powder of Comparative Example 1 had peaks at 2θ=15.8° and 17.0° in the diffraction angle range of 2θ=10° to 80° in the X-ray diffractogram shown in FIG. 1. The full widths at half maximum of these peaks were 0.22° and 0.22°, respectively, and the crystallite sizes calculated based on these values were D₍₁₁₋₁₎=41 nm and D₍₀₂₀₎=41 nm, respectively. On the other hand, no peak was observed in the vicinity of 2θ=53.0° in the X-ray diffractogram shown in FIG. 1.

Peak deconvolution was performed on the X-ray diffractogram shown in FIG. 1, which revealed that the powder of Comparative Example 2 had peaks at 2θ=15.8° and 17.0° in the diffraction angle range of 2θ=10° to 80°. The full widths at half maximum of these peaks were 2.9° and 2.9°, respectively, and the crystallite sizes calculated based on these values were D₍₁₁₋₁₎=3.1 nm and D₍₀₂₀₎=3.1 nm, respectively. Peaks were also observed at 2θ=24.4°, 33.0°, and 54.0° in the X-ray diffractogram of Comparative Example 2. These results confirmed that the powder of Comparative Example 2 had a crystal structure similar to that of crystalline divanadium trioxide (V₂O₃), which is an impurity.

### Test Example 2: High-resolution Transmission Electron Microscopy (HR-TEM) Observation

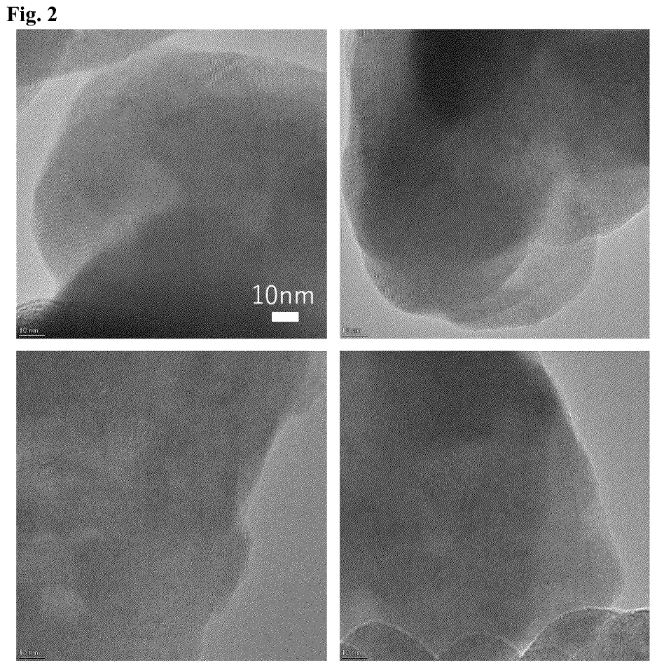

High-resolution transmission electron microscopy (HR-TEM) observations of the powders obtained in Example 1, Comparative Example 1, and Comparative Example 2 were performed under the following measurement conditions:
Measuring device: Talos F200X (Thermo Fisher Scientific)
Acceleration voltage: 300 kV and 300 pA
Measurement conditions: Dispersed on carbon film supported by copper mesh
FIGS. 2 to 4 show the results. In FIGS. 2 to 4, the scale bar represents a length of 10 nm.

The HR-TEM images shown in FIG. 2 show no crystal lattice fringes originating from crystalline domains in the powder of Example 1, which indicates high uniformity within the particles of Example 1.

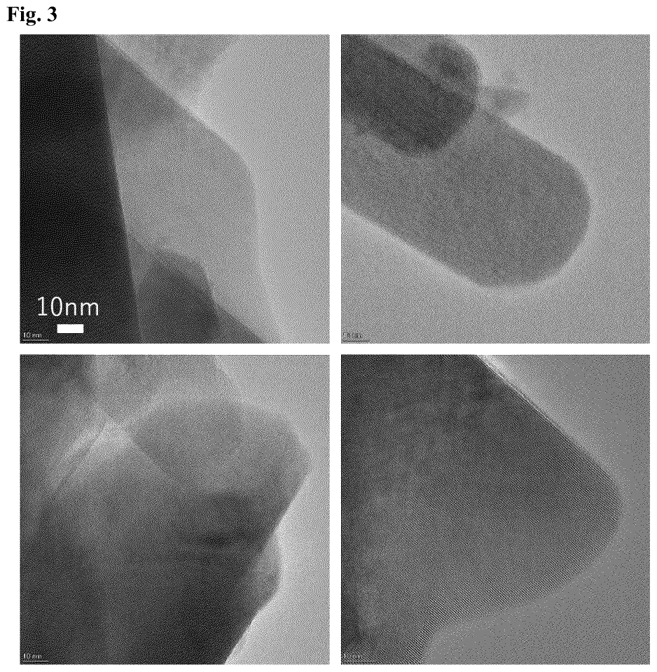

The HR-TEM images shown in FIG. 3 clearly show crystal lattice fringes originating from crystalline domains in the powder of Comparative Example 1.

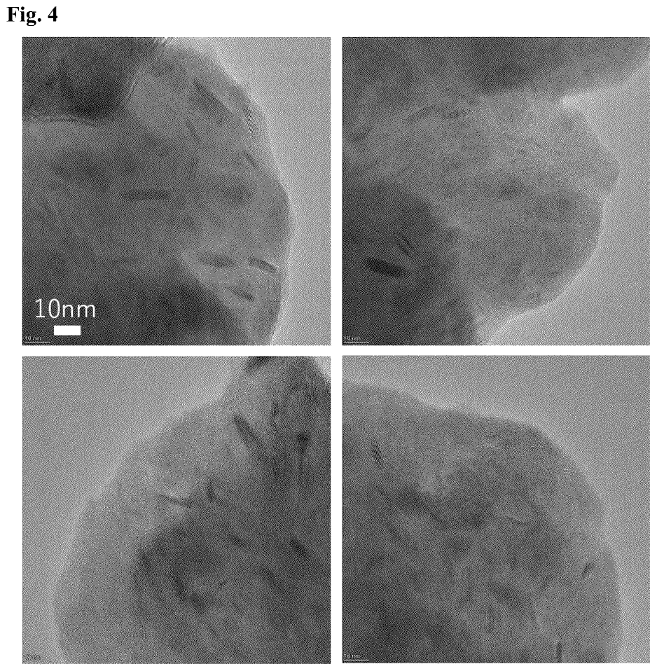

The HR-TEM images shown in FIG. 4 clearly show crystal lattice fringes (dark areas in the figure) in the powder of Comparative Example 2, which confirmed that microcrystalline domains corresponding to these crystal lattice fringes were distributed throughout the particles. These results indicate that the uniformity inside the particles of Comparative Example 2 was not high. If a crystalline vanadium sulfide with low uniformity inside the particles is used as an electrode active material, cycle characteristics tend to deteriorate because delamination readily occurs at the interfaces of crystalline domains due to the expansion of the crystalline domains after repeated charge-discharge cycles to some extent.

### Test Example 3: Particle Size Measurement

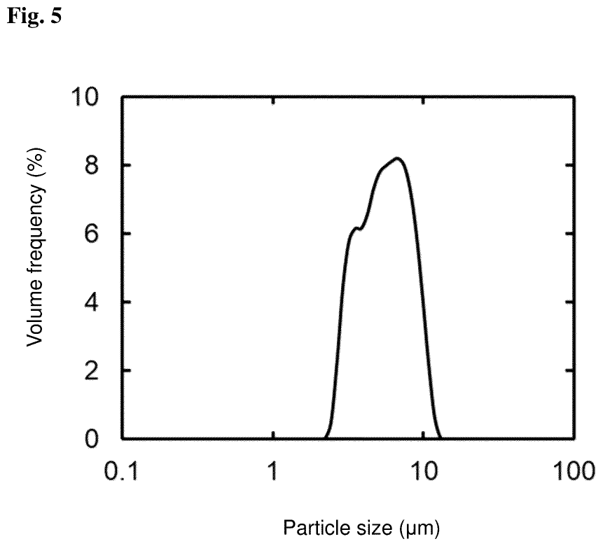

The particle size of the powder obtained in Example 1 was measured under the following conditions:
Measuring device: AEROTRAC II (MicrotracBEL)
Measurement conditions: Discharge pressure: 0.3 MPa
FIG. 5 shows the particle size distribution (histogram).

As shown in FIG. 5, the vanadium sulfide powder obtained in Example 1 had an average particle size D50 of 5.8 μm. The vanadium sulfide powder obtained in Comparative Example 1 had an average particle size D50 of 8.0 μm. The vanadium sulfide powder obtained in Comparative Example 2 had an average particle size D50 of 2.7 μm.

### Test Example 4: Charge-and-Discharge Test

Subsequently, electrochemical cells for testing (lithium secondary batteries) were produced by the following method using the vanadium sulfide powders obtained in Example 1 and Comparative Example 2 as cathode active materials, and constant-current charge-and-discharge measurement was performed at 25° C. and 60° C. at a current density of 10 mA/g (charge-and-discharge rate: 0.01 C) in the voltage range of 1.5 to 3.0 V with a pause of 10 minutes between cycles.

The electrochemical cell for testing was produced by assembling an all-solid-state lithium-ion secondary battery using the obtained vanadium sulfide as the cathode active material, a lithium-indium alloy as the anode, and an argyrodite-type sulfide-based solid electrolyte as the electrolyte. Then, charge-and-discharge testing was performed. As the cathode, a cathode composite prepared by mixing the vanadium sulfide powder, an argyrodite-type sulfide-based solid electrolyte, and acetylene black in a mass ratio of 80:18:2 was used. The cathode composite, the argyrodite-type sulfide-based solid electrolyte, and lithium-indium foil were subjected to compression molding to thus produce a pellet battery with a diameter of 10 mm.

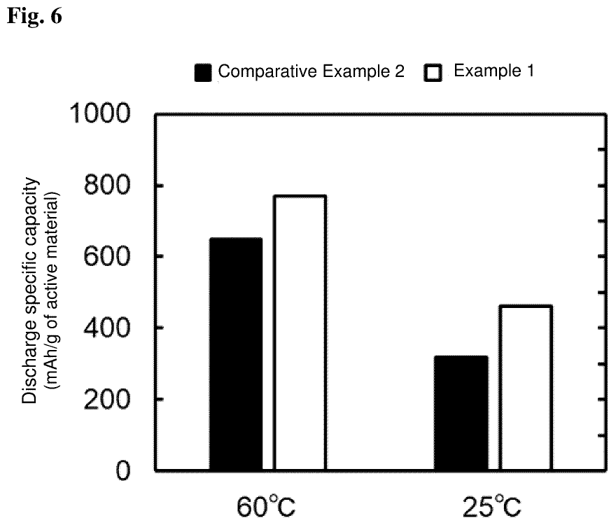

FIG. 6 shows the results. According to the results, when the vanadium sulfide powder obtained in Example 1 was used, a high discharge specific capacity (25° C.: 461 mAh/g; 60° C.: 769 mAh/g) was obtained in testing using the all-solid-state battery cell. In contrast, when the powder obtained in Comparative Example 2 was used, a lower discharge specific capacity (25° C.: 317 mAh/g; 60° C.: 649 mAh/g) was obtained, compared to Example 1.

1. A low-crystalline vanadium sulfide comprising vanadium and sulfur as constituent elements,
wherein the composition ratio of the sulfur to the vanadium (S/V) is 3.5 or more in terms of the molar ratio,
the average particle size D50 is 10 μm or less, and
the low-crystalline vanadium sulfide has no peak at a diffraction angle of 2θ=53.0° with a tolerance of ±1.0° in an X-ray diffractogram obtained using Cu Kα radiation.

2. The low-crystalline vanadium sulfide according to claim 1, which has a composition represented by formula (1):
VSₓ (1)
wherein x is 3.5 or more.

3. The low-crystalline vanadium sulfide according to claim 1, which has a VS₄-type crystal structure.

4. The low-crystalline vanadium sulfide according to claim 1,
wherein the low-crystalline vanadium sulfide has peaks at 2θ=15.8° and 17.0° with a tolerance of ±1.0° in the X-ray diffractogram, and
crystallite sizes calculated from the full widths at half maximum of the peaks at 2θ=15.8° and 17.0° are both 15 nm or less.

5. The low-crystalline vanadium sulfide according to claim 4,
wherein the low-crystalline vanadium sulfide has no peaks at 2θ=24.4° and 33.0° with a tolerance of ±1.0° in the X-ray diffractogram, or
the areas of peaks with local maxima at 2θ=24.4° and 33.0° are both 20% or less of the area of the smaller of the two peaks with local maxima at 2θ=15.8° and 17.0° with a tolerance of ±1.0° in the X-ray diffractogram.

6. A method for producing the low-crystalline vanadium sulfide according to claim 1, comprising:
a hydrothermal treatment step of subjecting a raw material containing a vanadate and a sulfur-containing compound to hydrothermal treatment at 100° C. to 160° C. in the absence of a carrier.

7. The production method according to claim 6, wherein the amount of the sulfur-containing compound used is 3.5 to 5.0 mol per mol of the vanadate.

8. An electrode active material for lithium-ion secondary batteries, comprising the low-crystalline vanadium sulfide according to claim 1.

9. An electrode for lithium-ion secondary batteries, comprising the electrode active material for lithium-ion secondary batteries according to claim 8.

10. A lithium-ion secondary battery comprising the electrode for lithium-ion secondary batteries according to claim 9.
